(19) United States
(12) Patent Application Publication
(10) Pub. No.: US 2023/0175851 A1
(43) Pub. Date: Jun. 8, 2023

(54) DATA-ANALYSIS-BASED NAVIGATION SYSTEM ASSISTANCE

(71) Applicant: KYNDRYL, INC., New York, NY (US)

(72) Inventors: Vidula M. PATEL, Elmhurst, IL (US); Shikhar KWATRA, San Jose, CA (US); Kristen CONLEY, Cuba City, WI (US); Erick BLACK, Franktown, CO (US)

(21) Appl. No.: 17/543,853

(22) Filed: Dec. 7, 2021

(51) Int. Cl. G01C 21/34

(52) U.S. Cl. CPC G01C 21/3492

(57) ABSTRACT

Data-analysis-based processing is provided to detect that a potential traffic event identified by a navigation system for a travel route is FALSE. The processing obtains movement data from multiple devices associated with one or more vehicles passing along the travel route in the vicinity of the potential traffic event, where the multiple devices are multiple electronic devices with Global Positioning System (GPS) capability, and obtains, based on the movement data, relative movement data between devices of the multiple devices associated with the one or more vehicles. Based at least in part on the relative movement data between devices of the multiple devices, the processing ascertains that the detected potential traffic event is FALSE, and initiates an action based on determining that the detected potential travel event is a FALSE traffic event.

### BACKGROUND

A navigation device is a device with navigation capability that aids a user in navigation. Navigation devices include a mobile device, such as a vehicle-associated device, or a handheld electronic device, or portable computer, with navigation capability. A global positioning system (or GPS system) supports and/or is integrated with GPS navigation devices, and uses groups of satellites that receive signal data from, for instance, a moving electronic device, and uses the signal data to triangulate, and thus, position the electronic GPS device, and therefore the user of the electronic device. Such navigation systems are installed on a large share of mobile devices today, and typically provide a user with maps and routing information for navigation assistance to a desired location.

Conventionally, a navigation system provides an indication of one or more routes available, and at each turn, a particular route to be taken to arrive at the desired destination. In one or more embodiments, the navigation system provides a shortest route between two locations, and generates a navigation route with turn-by-turn navigation directions and distances based on road numbers and/or road names for a user to follow.

### SUMMARY

Certain shortcomings of the prior art are overcome and additional advantages are provided through the provision, in one or more aspects, of a computer program product for facilitating processing within a computing environment. The computer program product includes one or more computer-readable storage media having program instructions embodied therewith. The program instructions are readable by a processing circuit to cause the processing circuit to perform a method which includes determining, via data-analysis, that a potential traffic event detected by a navigation system for a travel route is FALSE, and does not require re-routing. The determining includes obtaining movement data for multiple devices associated with one or more vehicles passing along the travel route in the vicinity of the potential traffic event, where the multiple devices are multiple electronic devices with Global Position System (GPS) capability, and obtaining, based on the movement data, relative movement data between devices of the multiple devices associated with the one or more vehicles. Further, the determining includes ascertaining, based at least in part on the relative movement data between devices of the multiple devices associated with the one or more vehicles passing along the travel route, that the potential traffic event is FALSE. The method further includes initiating an action based on determining that the potential traffic event is a FALSE traffic event.

Computer systems and computer-implemented methods relating to one or more aspects are also described and claimed herein. Further, services relating to one or more aspects are also described and may be claimed herein.

Additional features and advantages are realized through the techniques described herein. Other embodiments and aspects of the invention are described in detail herein and are considered a part of the claimed aspects.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a computing environment to incorporate and use one or more aspects of the present invention;

FIG. 2 depicts a further example of a computing environment to incorporate and use one or more aspects of the present invention;

FIG. 3 illustrates another example of a computing environment to incorporate and use one or more aspects of the present invention;

FIG. 4 illustrates various aspects of some embodiments of the present invention;

FIG. 5 depicts one embodiment of a workflow illustrating certain aspects of one or more embodiments of the present invention;

FIGS. 6A-6B depict a further workflow illustrating certain aspects of one or more embodiments of the present invention;

FIG. 7A depicts yet another example of a computing environment to incorporate and use one or more aspects of the present invention;

FIG. 7B depicts further details of the memory of FIG. 7A, in accordance with one or more aspects of the present invention;

FIG. 8 depicts one embodiment of a cloud computing environment, in accordance with one or more aspects of the present invention; and

FIG. 9 depicts one example of abstraction model layers, in accordance with one or more aspects of the present invention.

### DETAILED DESCRIPTION

The accompanying figures, which are incorporated in and form a part of this specification, further illustrate the present invention and, together with the detailed description of the invention, serve to explain aspects of the present invention. Note in this regard that descriptions of well-known systems, devices, global positioning systems (GPS), processing techniques, etc., are omitted so as to not unnecessarily obscure the invention in detail. Further, it should be understood that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further, that numerous inventive aspects and features are disclosed herein, and unless inconsistent, each disclosed aspect or feature is combinable with any other disclosed aspect or feature as desired for a particular application of the concepts disclosed herein.

Note also that illustrative embodiments are described below using specific code, designs, architectures, protocols, layouts, schematics or tools, only as examples, and not by way of limitation. Further, the illustrative embodiments are described in certain instances using particular hardware, software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

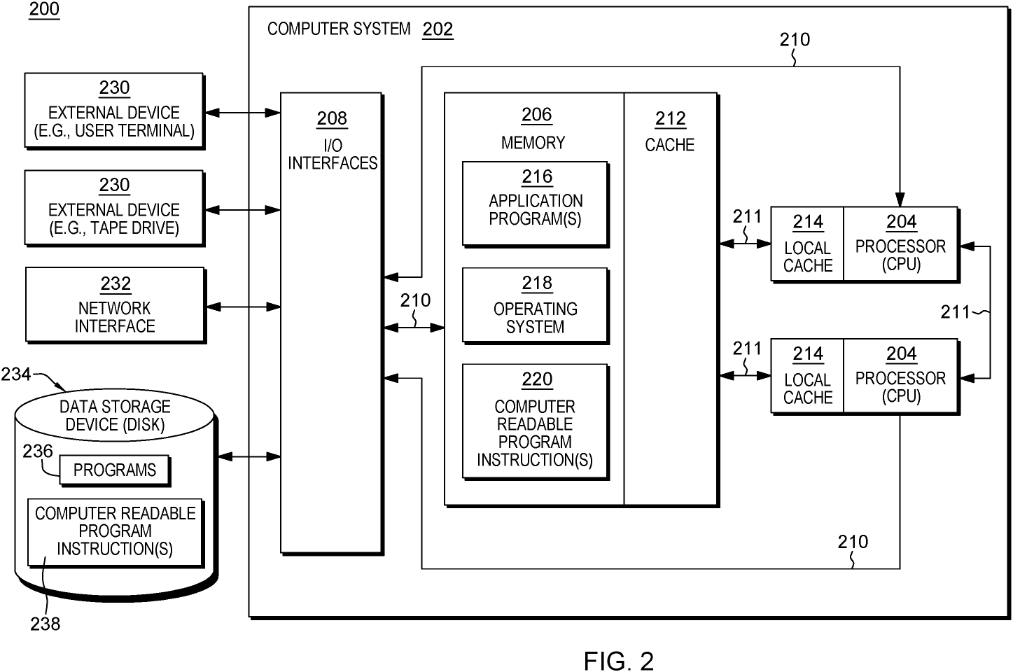

As understood by one skilled in the art, program code, as referred to in this application, can include both hardware and software. For example, program code in certain embodiments of the present invention can include fixed function hardware, but other embodiments can utilize a software-based implementation of the functionality described. Certain embodiments combine both types of program code. One example of program code, also referred to as one or more programs or program instructions, is depicted in FIG. 2 as one or more of application program(s) 216, and computer-readable program instruction(s) 220, stored in memory 206 of computing environment 200, as well as programs 236 and computer-readable program instruction(s) 238, stored in a data storage device 234 accessed by, or within, computing environment 200.

Route guidance via navigation system assistance is an ever-growing industry. Many electronic devices, such as smartphones, and portable computers, are capable of facilitating route navigation using mobile application software that utilize GPS signals from multiple satellites. The electronic GPS device, or generally the device, can include a GPS receiver that can be either software-based or hardware-based, or a combination thereof. In one or more embodiments, such user and/or vehicle devices include and/or are considered part of, a navigation system (that is a computing system) that aids in user or vehicle navigation. In one or more embodiments, a navigation system can be entirely onboard a vehicle, or even within a device, or distributed between one or more devices or one or more computing resources. Where a navigation system is located remotely, signals, such as microwave signals, radio signals or other signals, can be used to facilitate sending of directional guidance, or (for instance) control of an autonomous vehicle, when desired. By way of example, navigation systems can include maps, which can be displayed in human-readable format via text or in graphical format, code to determine a vehicle or device’s location via sensors, such as from external computing sources, code to provide suggested directions to an operator of a vehicle, code to provide directions to an autonomous vehicle, code to provide information on nearby vehicles or other hazards or obstacles, and in particular, to provide information on any potential traffic-affecting event (referred to herein as a potential traffic event) along a travel route of a vehicle, and suggest alternative travel routes or directions.

As used herein, a navigation system is a computing system that determines the position of a vehicle, or device, and provides a user/vehicle route to a particular desired location. In one or more implementations, the navigation system uses GPS signals to determine the vehicle’s (or device’s) current location and direction. For instance, the GPS navigation system can utilize GPS tracking or monitoring via the Global Navigation Satellite System (GNSS) network. In one implementation, the network incorporates a range of satellites that use microwave signals that are transmitted to GPS devices to give information on device location, device vehicle speed, time and direction.

A navigation system typically provides an indication of one or more routes available, and at each turn, a particular route to be taken to arrive at a desired destination. In one or more embodiments, the navigation system can provide a shortest route between two locations, and generate navigation route guidance with turn-by-turn navigation directions and distances based on road numbers and/or road names for a user to follow. Further, in one or more implementations, a navigation system can detect, by a variety of mechanisms, the existence of a potential traffic event (i.e., a potential traffic-affecting event) along a travel route, and potentially re-route a user or vehicle based on the detected potential traffic event. For instance, where a large number of GPS-enabled devices (also referred to herein as devices) are detected as stationary in an area, location, or common vicinity, along a travel route, the navigation system can potentially identify that data as indicating that a traffic-affecting event has occurred or exists along the travel route at that location. Based on this, the navigation system can, in one embodiment, re-route one or more vehicles travelling along the travel route to avoid the potential traffic event. The action of re-routing one or more vehicles, however, can have unintended results and associated costs, such as resulting in causing traffic delays along alternative routes which may be undersized to handle a volume of traffic being rerouted. This is particularly problematic where the potential traffic event is in actuality a FALSE traffic event, having being falsely identified by the navigation system.

Disclosed herein, in one or more embodiments, are a computer program product, computer system and computer-implemented method which include, for instance, program code executing on one or more processors that determines, via data analysis, that a potential traffic event detected by a navigation system for a travel route is FALSE and does not require re-routing. The determining includes obtaining movement data from multiple devices associated with one or more vehicles passing along the travel route in the vicinity of the potential traffic event, where the multiple devices are multiple electronic devices with Global Positioning System (GPS) capability. Further, the determining obtains, based on the movement data, relative movement data between devices of the multiple devices associated with the one or more vehicles, and ascertains, based at least in part on the relative movement data between devices of the multiple devices associated with the one or more vehicles, that the potential traffic event is FALSE. The program code can then initiating an action based on determining that the potential traffic event is a FALSE traffic event. For instance, a variety of traffic-affecting actions can be initiated by the data-analysis-based assist system to optimize traffic flow, for example, by minimizing traffic re-routing when a potential traffic event is determined to be a FALSE event. In another example, an action can be initiated for a driver or an autonomous vehicle to stay on a current travel route, notwithstanding the potential traffic event, based on the potential traffic event being determined to be FALSE. In one or more implementations, updated directions can also be sent to a navigation device associated with one or more vehicles traveling along the travel route and/or one or more devices traveling along the travel, based on the determining that the potential traffic event is FALSE.

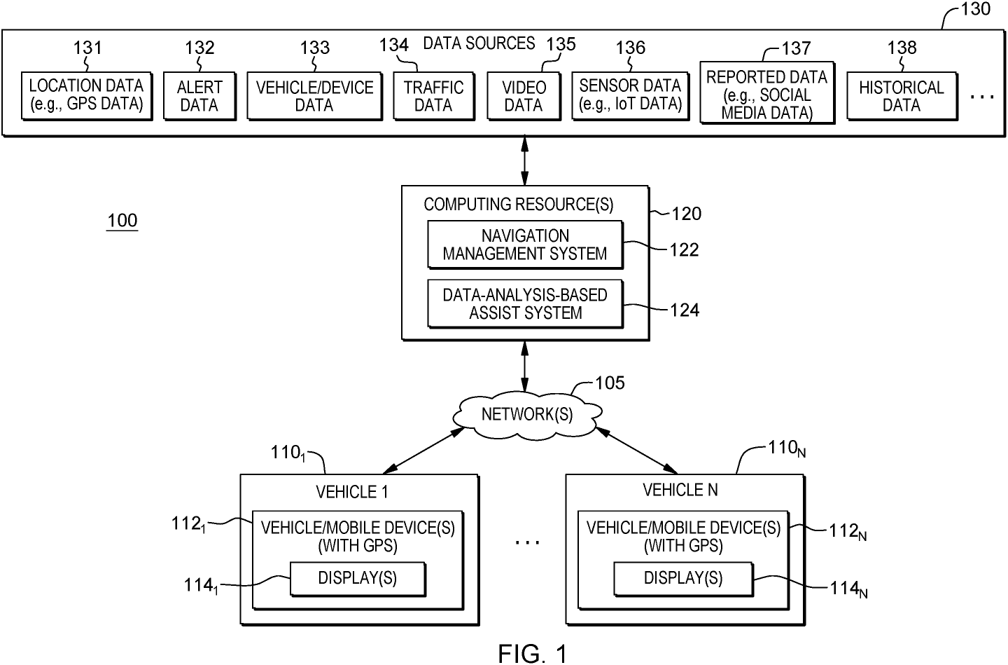

By way of example, FIG. 1 depicts one embodiment of a computing environment to incorporate and use one or more aspects of the present invention. FIG. 1 provides only an illustration of one implementation, and does not imply any limitations with regard to the environments in which different embodiments can be implemented. Many modifications to the depicted environment can be made by those skilled in the art without departing from the scope of the invention, as recited in the claims presented herewith.

As illustrated, computing environment 100 includes multiple devices, such as vehicle/mobile devices 112₁ ... 112_{N} associated with, or traveling within, multiple vehicles 110i ... 110_{N} passing along a travel route and being monitored by a navigation system, or navigation management system 122, executing on one or more computing resources 120. In one or more embodiments, a data-analysis-based assist system, module, logic, etc., can be provided separate from or integrated within navigation management system 122 and can include program code that generates or updates a model, based on machine learning, and utilizes the model to verify, for instance, traffic events occurring along a travel route, and/or to determine that a potential travel event detected for a travel route is FALSE, and does not require re-routing of one or more vehicles traveling along the travel route (such as disclosed herein).

In one implementation, vehicle/mobile devices 112₁ ... 112_{N} have GPS capability and associated displays 114i ... 114_{N} for, for instance, displaying navigational assistance provided by the navigation management system 122, and/or the data-analysis-based assist system 124. Navigational directions and assistance can be provided via one or more networks 105 communicatively coupling navigation management system 122 and data-analysis-based assist system 124 and vehicle/mobile devices 114₁ ... 114_{N} associated with vehicles 110₁ ... 110_{N} passing along the travel route. By way of example, and depending on location of the systems within computing environment 100, network(s) 105 can be a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, such as discussed herein, including in one or more embodiments, navigational assistance data.

In one or more embodiments, the data-analysis-based navigation assist system disclosed herein obtains and uses data from multiple data sources 130 to predictively determine (for instance, via machine learning) that a potential traffic event detected by the navigation system for a travel route is FALSE, and does not require re-routing. These data sources 130 can include, for instance, location data (such as GPS data) 131 for multiple devices associated with vehicles traveling along the travel route, alert data 132 (such as any previously reported traffic-affecting alerts associated with the travel route), vehicle/device data 133, current traffic data 134, traffic-related video data 135, traffic-related sensor data 136, such as Internet of Things (IoT) sensor data, reported social media data 137 related to traffic, historical traffic data 138 for the travel route, etc. In one or more implementations, the vehicle data can include specification data on one or more vehicles passing along the travel route, such as size and type of vehicle, and device data can include, for instance, current usage data of the device by one or more occupants of one or more vehicles traveling along the travel route. Note in this regard that, to the extent implementations of the present invention collect, store, or employ personal information provided by, or obtained from, individual users (for example, current locations of vehicles, current usage data of devices, social media data of users, etc.), such information shall be used in accordance with all applicable laws concerning protection of personal information. Additionally, the collection, storage and use of such information may be subject to consent of the individual to such activity, for example, through “opt-in” or “opt-out” processes, as may be appropriate for the situation and type of information. Storage and use of personal information may be of any appropriately secure manner reflective of the type of information, for example, through various encryption and anonymization techniques. In one or more embodiments, a anonymization processing is employed to ensure that substantially no personal information is used by the navigation management system, or the data-analysis-based assist system disclosed herein. Note further that, in one or more implementations, the data-analysis-based facility disclosed herein can be incorporated into a navigation management system (or navigation system) or can execute separate from the navigation management system, such as in a cloud-based implementation thereof, where the navigation system is incorporated or implemented in one or more vehicle/mobile devices.

Disclosed herein, in one or more embodiments, are computer program products, computer systems and computer-implemented methods which include program code that identifies and mitigates a FALSE positive detection of a traffic event by a navigation system, and in so doing, facilitates traffic flow by optimizing traffic re-routing only where necessary. In one or more embodiments, the data-analysis-based navigation assist system evaluates data representative of collaborative speed conditions, distance between vehicles or devices, pace of vehicles/devices, breaking variations, directions of vehicles, etc., in order to identify if the navigation system is correctly identifying a traffic-affecting event, as opposed to, for instance, falsely identifying a traffic event where there are a number of devices associated with a particular user or vehicle at a common location.

In one or more implementations, the data-analysis-based navigation assist processing disclosed herein integrates predictions based on machine learning using, for instance, anticipated traffic volumes along the travel route for particular days, times of day, locations along the route, as well as from recorded data, such as events occurring along the travel route (e.g., start and finish event times for a concert, different venues, etc.), current weather-related data, available traffic-related data, as well as predicted timeframes on events finishing, which can increase traffic volumes along the travel route.

Further, in one or more implementations, the data-analysis-based facilitation of navigation system assistance disclosed herein can utilize data transmission and/or usage data for one or more devices associated with one or more vehicles traveling along the travel route. For instance, in a vehicle that is idle, one or more occupants of the vehicle are more likely to be using data bandwidth, such as texting, emailing, playing games, etc., on one or more mobile devices than a user who is preoccupied with, for instance, driving the vehicle.

In one or more implementations, reported data, including social media data, can be utilized by the data-analysis-based navigation assist system disclosed herein to, for instance, determine whether a potential traffic event is TRUE, or FALSE. Taking into consideration local media reporting, police reporting, and other reported data available online, in comparison to having only GPS-based, location-enabled data of the devices associated with the vehicles traveling along the travel route, can assist in determining where true that a potential traffic event detected by the navigation system for a travel route is FALSE.

Note further that embodiments of the present invention are inextricably tied to computing and provide significantly more than existing navigation system implementations. Embodiments of the present invention enable program code executing on one or more processors or computing resources to exploit the interconnectivity of various systems, as well as utilize various computing-centric data analysis and handling techniques, in order to determine when a potential traffic event detected by a navigation system for a travel route is FALSE, and does not require re-routing, and to initiate an action based on determining that the potential traffic event is FALSE. Both the interconnectivity of the computing systems and the computing-centric data processing techniques utilized by the program code enable various aspects of the present invention. Further, embodiments of the present invention provide significantly more functionality than existing navigational system approaches because, in embodiments of the present invention, the program code determines when a potential traffic event detected by a navigation system for a travel route is a FALSE traffic event.

One embodiment of a computing environment to incorporate and use one or more aspects of the present invention is described with reference to FIG. 2. As an example, the computing environment is based on the IBM® z/Architecture® instruction set architecture, offered by International Business Machines Corporation, Armonk, New York. One embodiment of the z/Architecture instruction set architecture is described in a publication entitled, “z/Architecture Principles of Operation,” IBM Publication No. SA22-7832-12, Thirteenth Edition, September 2019, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction.

Referring to FIG. 2, a computing environment 200 includes, for instance, a computer system 202 shown, e.g., in the form of a general-purpose computing device. Computer system 202 can include, but is not limited to, one or more general-purpose processors or processing units 204 (e.g., central processing units (CPUs)), a memory 206 (a.k.a., system memory, main memory, main storage, central storage or storage, as examples), and one or more input/output (I/O) interfaces 208, coupled to one another via one or more buses and/or other connections. For instance, processors 204 and memory 206 are coupled to I/O interfaces 208 via one or more buses 210, and processors 204 are coupled to one another via one or more buses 211.

Bus 211 is, for instance, a memory or cache coherence bus, and bus 210 represents, e.g., one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

As examples, one or more special-purpose processors (e.g., neural network processors) (not shown) can also be provided separate from but coupled to the one or more general-purpose processors and/or can be embedded within the one or more general-purpose processors. Many variations are possible.

Memory 206 can include, for instance, a cache 212, such as a shared cache, which may be coupled to local caches 214 of processors 204 and/or to neural network processor, via, e.g., one or more buses 211. Further, memory 206 can include one or more programs or applications 216 and at least one operating system 218. An example operating system includes on IBM® z/OS® operating system, offered by International Business Machines Corporation, Armonk, New York. z/OS is a trademark or registered trademark of International Business Machines Corporation in at least one jurisdiction. Other operating systems offered by International Business Machines Corporation and/or other entities may also be used. Memory 206 can also include one or more computer readable program instructions 220, which can be configured to carry out functions of embodiments of aspects of the present invention.

Moreover, in one or more embodiments, memory 206 can include processor firmware (not shown). Processor firmware can include, e.g., the microcode or millicode of a processor. It can include, for instance, the hardware-level instructions and/or data structures used in implementation of higher level machine code. In one embodiment, it includes, for instance, proprietary code that is typically delivered as microcode or millicode that includes trusted software, microcode or millicode specific to the underlying hardware and controls operating system access to the system hardware.

Computer system 202 can communicate via, e.g., I/O interfaces 208 with one or more external devices 230, such as a user terminal, a tape drive, a pointing device, a display, and one or more data storage devices 234, etc. A data storage device 234 can store one or more programs 236, one or more computer readable program instructions 238, and/or data, etc. The computer readable program instructions may be configured to carry out functions of embodiments of aspects of the invention.

Computer system 202 can also communicate via, e.g., I/O interfaces 208 with network interface 232, which enables computer system 202 to communicate with one or more networks, such as a local area network (LAN), a general wide area network (WAN), and/or a public network (e.g., the Internet), providing communication with other computing devices or systems.

Computer system 202 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 202. Examples, include, but are not limited to: microcode or millicode, device drivers, redundant processing units, external disk drive arrays, RAID systems, tape drives, and data archival storage systems, etc.

Computer system 202 can be operational with numerous other general-purpose or special-purpose computing system environments or configurations. Examples of well-known computing systems, environments, and/or configurations that are suitable for use with computer system 202 include, but are not limited to, personal computer (PC) systems, mobile devices, GPS-based devices, handheld or laptop devices, server computer systems, thin clients, thick clients, multiprocessor systems, microprocessor-based systems, set top boxes, programmable consumer electronics, network PCs, minicomputer systems, mainframe computer systems, and distributed cloud computing environments that include any of the above systems or devices, and the like.

In one example, a processor (e.g., processor 204) includes a plurality of functional components (or a subset thereof) used to execute instructions. These functional components can include, for instance, an instruction fetch component to fetch instructions to be executed; an instruction decode unit to decode the fetched instructions and to obtain operands of the decoded instructions; one or more instruction execute components to execute the decoded instructions; a memory access component to access memory for instruction execution, if necessary; and a write back component to provide the results of the executed instructions. One or more of the components can access and/or use one or more registers in instruction processing. Further, one or more of the components may (in one embodiment) include at least a portion of or have access to one or more other components used in performing neural network processing (or other processing that can use one or more aspects of the present invention), as described herein. The one or more other components can include, for instance, a neural network processing assist component (and/or one or more other components).

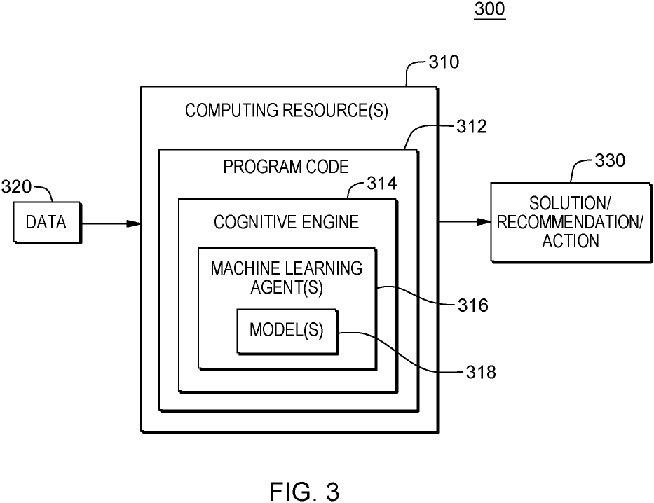

FIG. 3 depicts a further embodiment of a computing environment or system 300, incorporating, or implementing, certain aspects of an embodiment of the present invention. In one or more implementations, system 300 can be part of a computing environment, such as computing environment 100 described above in connection with FIG. 1 and/or computing environment 200 described above in connection with FIG. 2. System 300 includes one or more computing resources 310 that execute program code 312 that implements a cognitive engine 314, which includes one or more machine-learning agents 316, and one or more machine-learning models 318. Data 320, such as the data discussed herein, is used by cognitive engine 314, to train model(s) 318, to (for instance) predict one or more parameters of a traffic-effecting event, and to generate one or more solutions, recommendations, actions 330, etc., based on the particular application of the machine-learning model. In implementation, system 300 can include, or utilize, one or more networks for interfacing various aspects of computing resource(s) 310, as well as one or more data sources providing data 320, and one or more systems receiving the predicted geographic location and/or the output solution, recommendation, action, etc., 330 of machine-learning model(s) 318. By way of example, the network can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, predicted traffic event and an output solution, recommendation, action, of the machine-learning model, such as discussed herein.

In one or more implementations, computing resource(s) 310 houses and/or executes program code 312 configured to perform methods in accordance with one or more aspects of the present invention. By way of example, computing resource(s) 310 can be a traffic management system server, or other computing-system-implemented resource(s). Further, for illustrative purposes only, computing resource(s) 310 in FIG. 3 is depicted as being a single computing resource. This is a non-limiting example of an implementation. In one or more other implementations, computing resource(s) 310, by which one or more aspects of machine-learning processing such as discussed herein are implemented, could, at least in part, be implemented in multiple separate computing resources or systems, such as one or more computing resources of a cloud-hosting environment, by way of example.

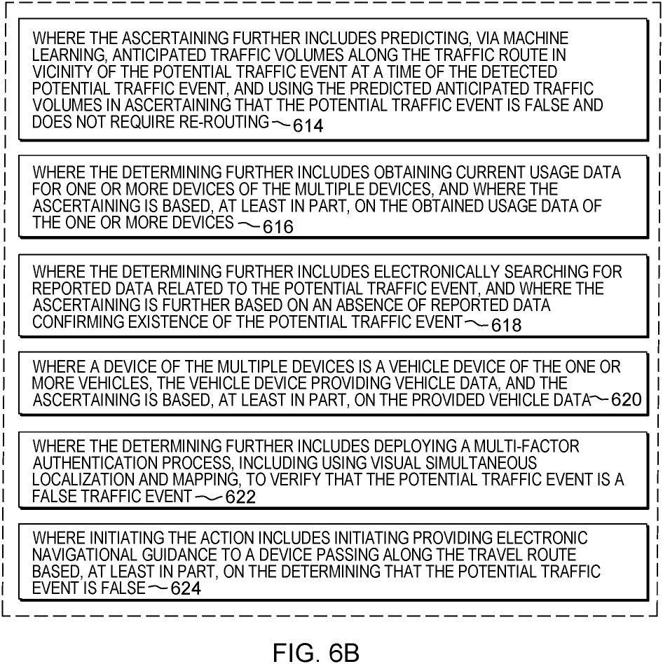

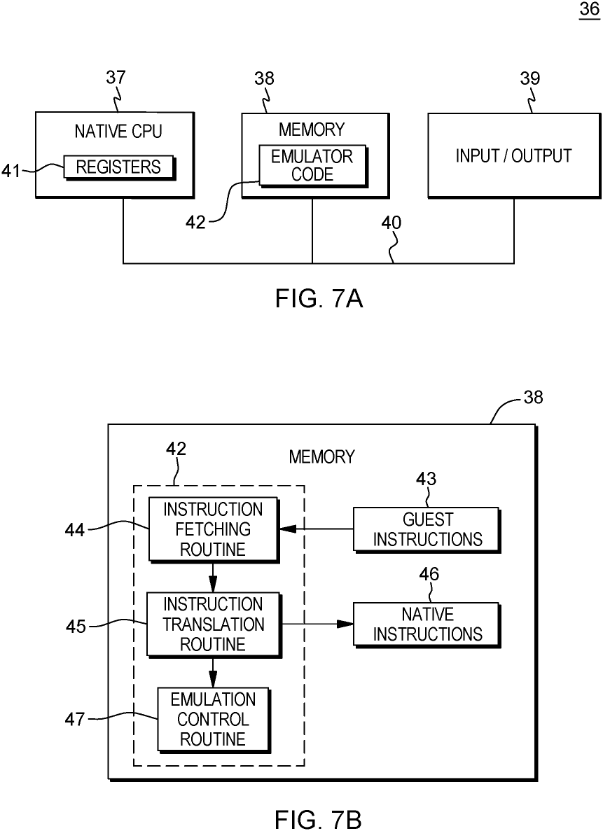

Briefly described, in one embodiment, computing resource(s) 310 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed herein are described further herein with reference to FIG. 2, as well as with reference to FIG. 7A-9.

As noted, program code 312 executes, in one implementation, a cognitive engine 314 which includes one or more machine-learning agents 316 that facilitate training one or more machine-learning models 318. The machine-learning models are trained using training data that can include a variety of types of data, depending on the model and the data sources. In one or more embodiments, program code 312 executing on one or more computing resources 310 applies machine-learning algorithms of machine-learning agent 316 to generate and train the model(s), which the program code then utilizes to predict, for instance, one or more parameters of a traffic-effecting event, and depending on the application, to perform an action (e.g., provide a solution, make a recommendation, perform a task, etc.). In an initialization or learning stage, program code 312 trains one or more machine-learning models 318 using obtained training data that can include, in one or more embodiments, network communication-related data associated with communications between servers of a network of a computing environment, such as described herein.

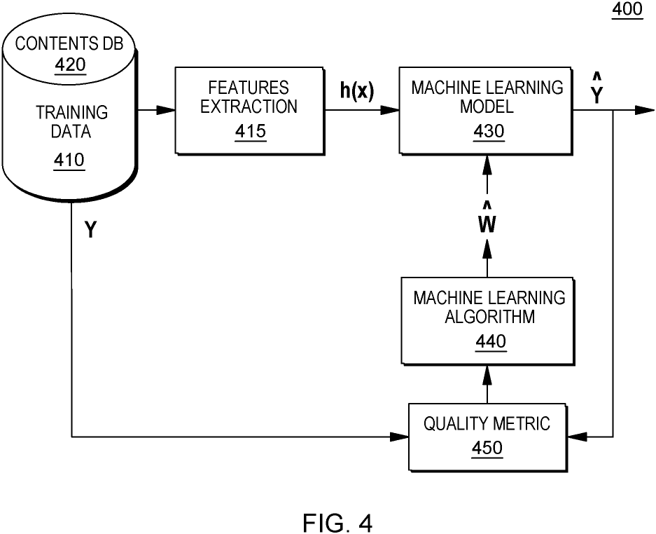

FIG. 4 is an example machine-learning training system 400 that can be utilized to perform machine-learning, such as described herein. Training data 410 used to train the model (in embodiments of the present invention) can include a variety of types of data, such as data generated by one or more network devices or computer systems in communication with the computing resource(s) 410. Program code, in embodiments of the present invention, can perform machine-learning analysis to generate data structures, including algorithms utilized by the program code to predict traffic-effecting event parameters, as well as detect false positive traffic events, and/or perform a machine-learning action. As known, machine-learning (ML) solves problems that cannot be solved by numerical means alone. In this ML-based example, program code extract features/attributes from training data 410, which can be stored in memory or one or more databases 420. The extracted features 415 are utilized to develop a predictor function, h(x), also referred to as a hypothesis, which the program code utilizes as a machine-learning model 430. In identifying machine-learning model 430, various techniques can be used to select features (elements, patterns, attributes, etc.), including but not limited to, diffusion mapping, principle component analysis, recursive feature elimination (a brute force approach to selecting features), and/or a random forest, to select the attributes related to the particular model. Program code can utilize a machine-learning algorithm 440 to train machine-learning model 430 (e.g., the algorithms utilized by program code), including providing weights for conclusions, so that the program code can train any predictor or performance functions included in the machine-learning model 440. The conclusions can be evaluated by a quality metric 450. By selecting a diverse set of training data 410, the program code trains the machine-learning model 440 to identify and weight various attributes (e.g., features, patterns) that correlate to enhanced performance of the machine-learned model.

Some embodiments of the present invention can utilize IBM Watson® as learning agent. IBM Watson® is a registered trademark of International Business Machines Corporation, Armonk, New York, USA. In embodiments of the present invention, the respective program code can interface with IBM Watson® application program interfaces (APIs) to perform machine-learning analysis of obtained data. In some embodiments of the present invention, the respective program code can interface with the application programming interfaces (APIs) that are part of a known machine-learning agent, such as the IBM Watson® application programming interface (API), a product of International Business Machines Corporation, to determine impacts of data on the machine-learning model, and to update the model, accordingly.

In some embodiments of the present invention, the program code utilizes a neural network to analyze training data and/or collected data to generate an operational model or machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

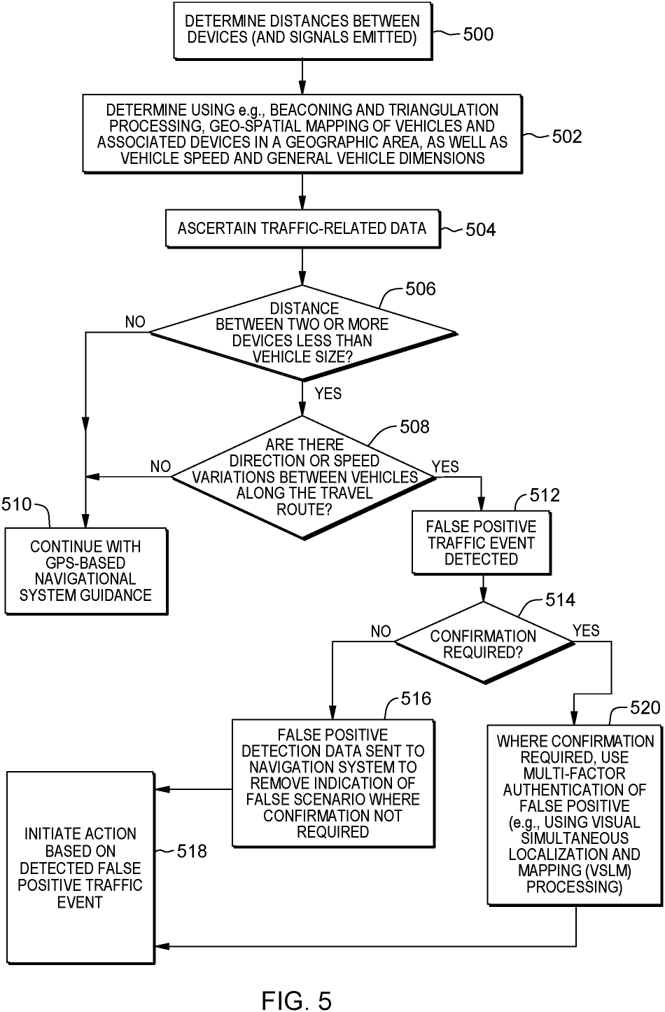

By way of further example, FIG. 5 depicts one embodiment of a workflow implemented by, for instance, a data-analysis-based navigation assist system, in accordance with one or more aspects of the present invention.

Referring to FIG. 5, as part of the workflow, the system determines distances between different devices passing along a travel route, for instance, via signals emitted by the devices 500. Beaconing mechanisms and triangulation processing is used by the system to, in one embodiment, determine geospatial mapping of vehicles passing along the travel route (as well as mobile devices in the geographic area) and vehicle speed and general vehicle dimensions 502. The system further ascertains, in one embodiment, traffic-related data 504, which can represent another set of input data for proximity of vehicles traveling along the travel route. For instance, vehicle data can be obtained on vehicle speed, including acceleration or deceleration. In one implementation, breaking of vehicles can be monitored using, for instance, Vehicle to Everything (V2X) communication protocol in order to identify if a defined number of signals are being emitted from a common geospatial location. As known, V2X is a vehicular communication system that supports transfer of information from a vehicle to moving parts of the traffic system that may affect the vehicle.

In one or more implementations, the system utilizes an ensemble model to eliminate FALSE positive potential traffic events along a traffic route by, for instance, converting categorical features into numerical data. In one or more embodiments, dimensions of vehicles can be obtained, and for instance, saved in a database such as a cloud-based database, in order to facilitate distance and dimension mapping in an application program interface. The rates of travel of vehicles determined by angular speed data and variations are ascertained, as well as overall moving conditions of the vehicles, via for instance, directional sensing data. In one or more embodiments, device social network information data can also be used to determine user device activity, such as data bandwidth consumed by devices in one or more vehicles passing along the travel route. Using the available data, the system determines whether the distance between mobile devices is less than the vehicle size 506. If “no”, then the system continues with conventional GPS-based navigational system guidance 510. In this case, the data-analysis-based assist system allows the navigation management system to proceed with providing directional assistance based on the detected potential traffic event.

In one embodiment, processing further determines whether there are direction or speed variations between the vehicles, or devices within the vehicles 508. For instance, the system determines (in one embodiment) an output that is a function of W1 × (distance if less than dimension of the vehicle) + W2 × (directional moving conditions of the vehicles), where W1, W2 are weights trained by machine learning. In one embodiment, the weights can be randomly assigned at first, and later selected based on back propagation. Weights can be back-propagated based on conditions. The distance is understood using an Euclidean distance directional algorithm. Moving conditions can be pushed from, for instance, a cloud-based resource to a vehicle or one or more devices associated with the vehicle. If there are no direction or speed variations between vehicles and/or devices, then the data-analysis-based assist system signals the navigational system to continue with GPS-based navigation system guidance 510.

In one embodiment, if the output result of the function is greater than a threshold, then a FALSE positive is detected (or triggered) into the navigation system 512. In one or more embodiments, the FALSE positive detection data (or signal) is sent to the navigation system to remove the detected potential traffic event determination as a FALSE scenario 516 where confirmation is unnecessary 514. This initiates an action to be taken based on the FALSE positive configuration 518, such as discussed herein. In particular, in certain situations, the navigation system (e.g., maps, API) can be signaled to remove the potential traffic event from a display, and remove the potential traffic event from consideration in the navigation directions.

In one embodiment, where confirmation is required, multi-factor authentication processing can be used to confirm the existence of a FALSE positive traffic event (e.g., using visual simultaneous localization and mapping (VSLAM) processing) 520. Once confirmed, one or more actions can be taken based on the FALSE positive scenario. In one embodiment, the multi-factor authentication (MFA) technique can be deployed in order to capture, for instance, vehicle dimensions, and identify if there is a FALSE traffic event indication. For instance, MFA can be implemented using one or more user devices associated with or connected to a vehicle, with the devices having device data and the vehicle having vehicle data. In one implementation, the data can be stored on a gateway on the vehicle device. Machine learning models running MFA processing can be implemented by pairing the devices. Further, available video data can be integrated into the confirmation process. The video data can be ascertained from external video sources along the travel route or, for instance, from one or more video sources associated with one or more vehicles traveling along the travel route. In another embodiment, where a potential traffic event is deemed FALSE, and confirmation is required, satellite imaging (or unmanned vehicle imaging) in the vicinity of the potential traffic event, or other video-based data, such as traffic signal video data, can be ascertained in order to perform the multi-factor authentication to confirm the FALSE positive nature of the potential traffic event. In one implementation, traffic signal video, or video from other video devices in the vicinity of the potential traffic event, capture one or more images, which are trained with different collations of data augmentation techniques and fed to a machine learning classifier, such as a You Only Look Once (YOLO) classifier for providing visual content information, if required, to the respective API sets.

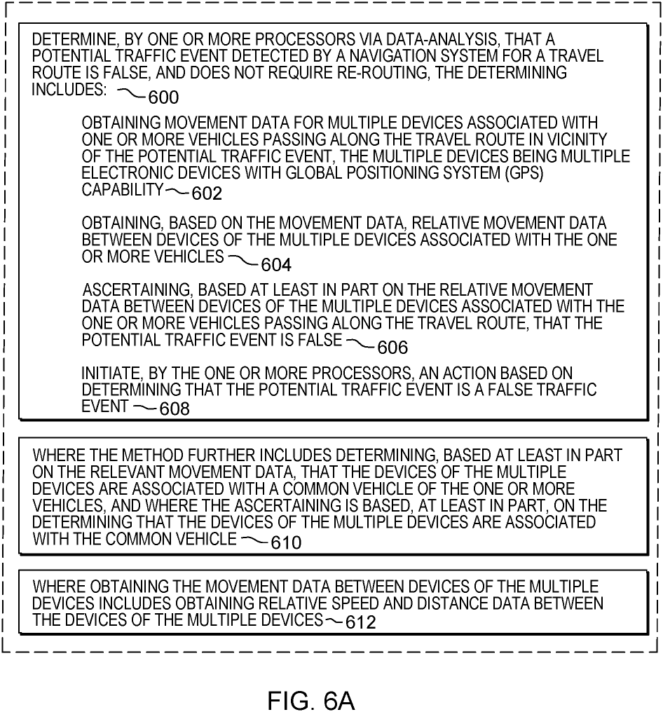

Further details of one embodiment of facilitating processing within a computing environment, as it relates to one or more aspects of the present invention, are described with reference to FIGS. 6A-6B.

Referring to FIG. 6A, in one embodiment, one or more processors determine via data analysis that a potential traffic event detected by a navigation system for a travel route is FALSE, and does not require re-routing of one or more vehicles 600. The determining includes obtaining movement data for multiple devices associated with one or more vehicles passing along the travel route in the vicinity of the potential traffic event. The multiple devices are multiple electronic devices with Global Positioning System (GPS) capability 602. Further, the determining includes obtaining, based on the movement data, relative movement data between devices of the multiple devices associated with the one or more vehicles 604, and ascertaining, based at least in part on the relative movement data between the devices of the multiple devices associated with the one or more vehicles passing along the travel route, that the potential travel event is FALSE 606. Further, an action is initiated, by the one or more processors, based on determining that the potential traffic event is a FALSE traffic event 608.

Advantageously, ascertaining, based at least in part on the relative movement data between the devices of the multiple devices associated with the one or more vehicles passing along the travel route, that the potential travel event is FALSE facilitates optimizing traffic routing by the navigation system. The processing avoids unnecessary traffic re-routing by mitigating FALSE positives. Further, the data-analysis-based navigation assist system can verify that a potential traffic-affecting event is TRUE, and depending on the results of the ascertaining, can initiate an action to have one or more drivers (or automated vehicles) change routes based on the data analysis.

In one example, the method further includes determining, based at least in part on the relevant movement data, that the devices of the multiple devices are associated with a common vehicle of the one or more vehicles, and where the ascertaining is based, at least in part, on the determining that the devices of the multiple devices are associated with a common vehicle 610. In one embodiment, obtaining the movement data between devices of the multiple devices includes obtaining relative speed and distance data between the devices of the multiple devices 612.

Referring to FIG. 6B, in a further aspect, the ascertaining includes predicting, via machine learning, anticipated traffic volumes along the traffic route in the vicinity (or at the location) of the potential traffic event at a time of the detected potential traffic event, and using the predicted anticipated traffic volumes in ascertaining that the potential traffic event is FALSE and does not require re-routing 614.

In one example, the determining further includes obtaining current usage data for one or more devices of the multiple devices, where the ascertaining is based, at least in part, on the obtained usage data of the one or more devices 616.

In one or more implementations, the determining further includes electronically searching for reported data related to the potential traffic event, where the ascertaining is further based on an absence of reported data confirming existence of the potential traffic event 618.

In one example, a device of the multiple devices is a vehicle device of the one or more vehicles, and the vehicle device provides vehicle data, where the ascertaining is based, at least in part, on the provided vehicle data 620.

In one implementation, the determining further includes deploying a multi-factor authentication process, including using visual simultaneous localization and mapping to verify that the potential traffic event is a FALSE traffic event 622.

In one example, initiating the action includes initiating providing electronic navigational guidance to a device passing along the travel route is based, at least in part, on the determining that the potential traffic event is FALSE 624.

Other variations and embodiments are possible.

Another embodiment of a computing environment to incorporate and use one or more aspects of the present invention is described with reference to FIG. 7A. In this example, a computing environment 36 includes, for instance, a native central processing unit (CPU) 37, a memory 38, and one or more input/output devices and/or interfaces 39 coupled to one another via, for example, one or more buses 40 and/or other connections. As examples, computing environment 36 may include a Power® processor offered by International Business Machines Corporation, Armonk, New York; an HP Superdome with Intel® processors offered by Hewlett Packard Co., Palo Alto, California; and/or other machines based on architectures offered by International Business Machines Corporation, Hewlett Packard, Intel Corporation, Oracle, and/or others. PowerPC is a trademark or registered trademark of International Business Machines Corporation in at least one jurisdiction. Intel is a trademark or registered trademark of Intel Corporation or its subsidiaries in the United States and other countries.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture. For instance, emulator code 42 allows machines based on architectures other than the z/Architecture instruction set architecture, such as Power processors, HP Superdome servers or others, to emulate the z/Architecture instruction set architecture and to execute software and instructions developed based on the z/Architecture instruction set architecture.

Further details relating to emulator code 42 are described with reference to FIG. 7B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the z/Architecture instruction set architecture, but instead, are being emulated on native CPU 37, which may be, for example, an Intel processor. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

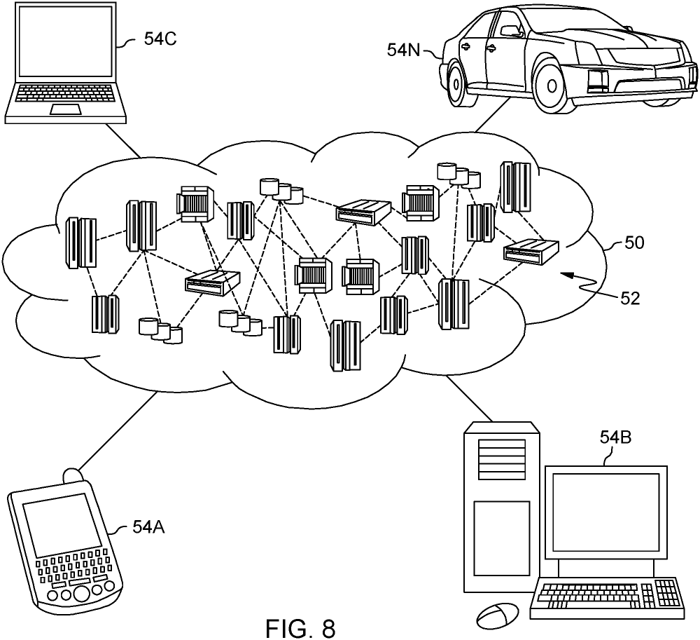

Referring now to FIG. 8, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 52 and cloud computing environment 50 can communicate with any type of computerized device over any type of network and/or network addressable connection (e.g., using a web browser).

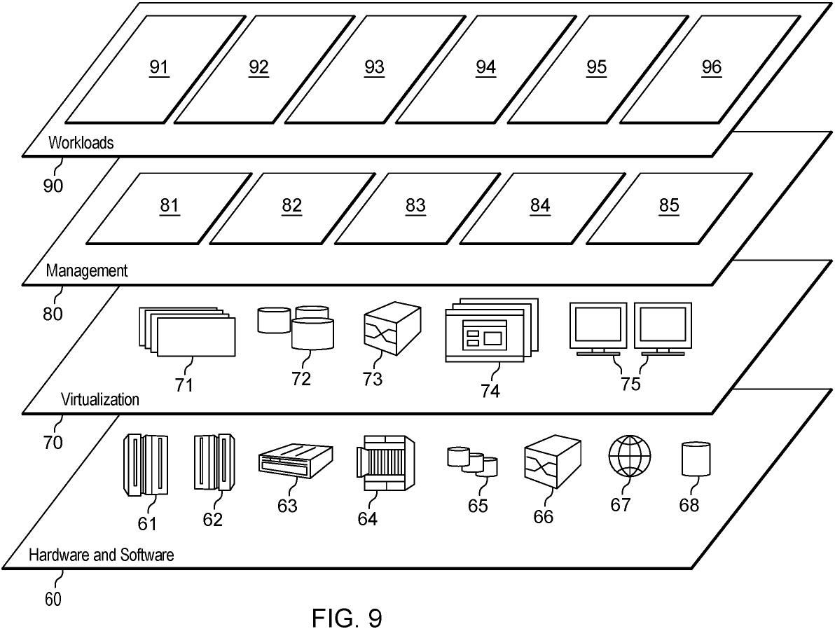

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and false positive detection processing 96.

Aspects of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For instance, computing environments of other architectures can be used to incorporate and/or use one or more aspects. Further, different instructions or operations may be used. Additionally, different types of registers and/or different registers may be used. Further, other data formats, data layouts and/or data sizes may be supported. In one or more embodiments, one or more general-purpose processors, one or more special-purpose processors or a combination of general-purpose and special-purpose processors may be used. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer-readable storage media having program instructions embodied therewith, the program instructions being readable by a processing circuit to cause the processing circuit to perform a method comprising:
determining, by one or more processors via data-analysis, that a potential traffic event detected by a navigation system for a travel route is FALSE, and does not require re-routing, the determining comprising:
obtaining movement data for multiple devices associated with one or more vehicles passing along the travel route in vicinity of the potential traffic event, the multiple devices being multiple electronic devices with Global Positioning System (GPS) capability;
obtaining, based on the movement data, relative movement data between devices of the multiple devices associated with the one or more vehicles;
ascertaining, based at least in part on the relative movement data between devices of the multiple devices associated with the one or more vehicles passing along the travel route, that the potential traffic event is FALSE; and
initiating, by the one or more processors, an action based on determining that the potential traffic event is a FALSE traffic event.

2. The computer program product of claim 1, wherein the method further comprises determining, based at least in part on the relevant movement data, that the devices of the multiple devices are associated with a common vehicle of the one or more vehicles, and wherein the ascertaining is based, at least in part, on the determining that the devices of the multiple devices are associated with the common vehicle.

3. The computer program product of claim 1, wherein obtaining the movement data between devices of the multiple devices comprises obtaining relative speed and distance data between the devices of the multiple devices.

4. The computer program product of claim 1, wherein the ascertaining further comprises predicting, via machine learning, anticipated traffic volumes along the traffic route in vicinity of the potential traffic event at a time of the detected potential traffic event, and using the predicted anticipated traffic volumes in ascertaining that the potential traffic event is FALSE and does not require re-routing.

5. The computer program product of claim 1, wherein the determining further comprises obtaining current usage data for one or more devices of the multiple devices, and wherein the ascertaining is based, at least in part, on the obtained usage data of the one or more devices.

6. The computer program product of claim 1, wherein the determining further comprises electronically searching for reported data related to the potential traffic event, and wherein the ascertaining is further based on an absence of reported data confirming existence of the potential traffic event.

7. The computer program product of claim 1, wherein a device of the multiple devices is a vehicle device of the one or more vehicles, the vehicle device providing vehicle data, and the ascertaining is based, at least in part, on the provided vehicle data.

8. The computer program product of claim 1, wherein the determining further comprises deploying a multi-factor authentication process, including using visual simultaneous localization and mapping to verify that the potential traffic event is a FALSE traffic event.

9. The computer program product of claim 1, wherein initiating the action comprises initiating providing electronic navigational guidance to a device passing along the travel route based, at least in part, on the determining that the potential traffic event is FALSE.

10. A computer system for facilitating processing within a computing environment, the computer system comprising:
a memory; and
a processing circuit in communication with the memory, wherein the computer system is configured to perform a method, the method comprising:
determining, by one or more processors via data-analysis, that a potential traffic event detected by a navigation system for a travel route is FALSE, and does not require re-routing, the determining comprising:
obtaining movement data for multiple devices associated with one or more vehicles passing along the travel route in vicinity of the potential traffic event, the multiple devices being multiple electronic devices with Global Positioning System (GPS) capability;
obtaining, based on the movement data, relative movement data between devices of the multiple devices associated with the one or more vehicles;
ascertaining, based at least in part on the relative movement data between devices of the multiple devices associated with the one or more vehicles passing along the travel route, that the potential traffic event is FALSE; and
initiating, by the one or more processors, an action based on determining that the potential traffic event is a FALSE traffic event.

11. The computer system of claim 10, wherein the method further comprises determining, based at least in part on the relevant movement data, that the devices of the multiple devices are associated with a common vehicle of the one or more vehicles, and wherein the ascertaining is based, at least in part, on the determining that the devices of the multiple devices are associated with the common vehicle.

12. The computer system of claim 10, wherein obtaining the movement data between devices of the multiple devices comprises obtaining relative speed and distance data between the devices of the multiple devices.

13. The computer system of claim 10, wherein the ascertaining further comprises predicting, via machine learning, anticipated traffic volumes along the traffic route in vicinity of the potential traffic event at a time of the detected potential traffic event, and using the predicted anticipated traffic volumes in ascertaining that the potential traffic event is FALSE and does not require re-routing.

14. The computer system of claim 10, wherein a device of the multiple devices is a vehicle device of the one or more vehicles, the vehicle device providing vehicle data, and the ascertaining is based, at least in part, on the provided vehicle data.

15. The computer system of claim 10, wherein the determining further comprises deploying a multi-factor authentication process, including using visual simultaneous localization and mapping to verify that the potential traffic event is a FALSE traffic event.

16. The computer system of claim 10, wherein initiating the action comprises initiating providing electronic navigational guidance to a device passing along the travel route based, at least in part, on the determining that the potential traffic event is FALSE.

17. A computer-implemented method of facilitating processing within a computing environment, the computer-implemented method comprising:
determining, by one or more processors via data-analysis, that a potential traffic event detected by a navigation system for a travel route is FALSE, and does not require re-routing, the determining comprising:
obtaining movement data for multiple devices associated with one or more vehicles passing along the travel route in vicinity of the potential traffic event, the multiple devices being multiple electronic devices with Global Positioning System (GPS) capability;
obtaining, based on the movement data, relative movement data between devices of the multiple devices associated with the one or more vehicles;
ascertaining, based at least in part on the relative movement data between devices of the multiple devices associated with the one or more vehicles passing along the travel route, that the potential traffic event is FALSE; and
initiating, by the one or more processors, an action based on determining that the potential traffic event is a FALSE traffic event.

18. The computer-implemented method of claim 17, further comprising determining, based at least in part on the relevant movement data, that the devices of the multiple devices are associated with a common vehicle of the one or more vehicles, and wherein the ascertaining is based, at least in part, on the determining that the devices of the multiple devices are associated with the common vehicle.

19. The computer-implemented method of claim 17, wherein obtaining the movement data between devices of the multiple devices comprises obtaining relative speed and distance data between the devices of the multiple devices.

20. The computer-implemented method of claim 17, wherein a device of the multiple devices is a vehicle device of the one or more vehicles, the vehicle device providing vehicle data, and the ascertaining is based, at least in part, on the provided vehicle data.
